(19) United States
(12) Patent Application Publication
(10) Pub. No.: US 2010/0036893 A1
(43) Pub. Date: Feb. 11, 2010

(54) ARCHITECTURE FOR ACCESSING A DATA STREAM BY MEANS OF A USER TERMINAL

(75) Inventors: Thomas Serval, Neuilly Sur Seine (FR); Olivier GIROUD, Courbevoie (FR); Olivier Giroud, Courbevoie (FR)

Correspondence Address: YOUNG & THOMPSON, 209 Madison Street, Suite 500, Alexandria, VA, 22314, US

(73) Assignee: BARACODA, Paris (FR)

(21) Appl. No.: 12/439,889

(22) PCT Filed: Sep. 4, 2007
(86) PCT No.: PCT/FR2007/051870

§ 371 Date: Sep. 16, 2009

(30) Foreign Application Priority Data
Sep. 4, 2006 (FR) 0653568

(51) Int. Cl. G06F 15/16; G06F 17/00; H04L 9/32; G06F 17/30; G06F 21/00

(52) U.S. Cl. 707/201; 700/94; 726/6; 709/231; 707/E17.005

(57) ABSTRACT

XML communication protocol between a user terminal, such as a radio alarm clock, and a services platform via the Internet network for accessing an audio file available from a data streaming server.

The present invention relates to the field of accessing, over a network, an audio file available from a download server or an audio stream available from a streaming server, and of playing back this file or stream by a user terminal.

The document U.S. Pat. No. 6,678,215 describes, from a very general point of view, an audio terminal, such as a radio alarm clock, connected to the Internet network to receive audio data. The audio data received by the terminal, which are compressed into standard formats, are decompressed by software means and played back by sound-reproducing means included in the radio alarm clock.

The digital audio contents currently available on the Internet come either from so-called “Internet radios” that broadcast their programs directly over the Internet network for them to be listened to in live; or from FM/AM radios that convert their programs into audio files that are accessible via the Internet site of the FM/AM radio; or else from any other content provider offering free or paying access to an audio file such as a publicity, a recorded program (for example of the “Podcast” type), a newspaper or magazine read by a person or a speech synthesis engine, a read book that is also called an “audio book”, one or more music tracks bought on the site of a record company, etc.

The servers that store or allow access to these files or data streams are designed either for a full download of the file on the user terminal, in the purpose of playing back this audio file with a delay; or for a partial continuous download of an audio stream to be played back with a slight delay, the size of the downloaded file portion being limited by the memory of the user equipment; or for a streaming of the file to be played back immediately or with very slight delay (storing of a buffer-volume of data to prevent any interruption of the sound reproduction in case of congestion of the network). The first method of data transfer between the content server and the user terminal is called “download”, the second method is called “progressive download”, and the third method is called “streaming”. The present invention relates exclusively to the last two methods. Hereinafter, the term “data streaming” will preferably be used, that combines together the two playback methods called “streaming” and “progressive download”.

There is a need for a user terminal that allows to listen to audio files from different sources and in different formats, via the Internet, but that is at the same time light-weight, portable and mobile, while having a reduced cost and numerous functionalities in keeping with the users' expectations.

It is an object of the present invention to provide a user terminal comprising:

storage means and calculation means;

a man-machine interface having display means and input means;

means for connection to a TCP/IP network, for accessing audio files available from audio streaming server, each audio file being located by an URL;

means for decoding the data stream transmitted by said server; and

means for reproducing sound from said decoded data stream,

characterized in that said storage means comprise a cache memory to store the terminal use history, said cache memory being a volatile memory and being of reduced size, and in that said terminal further comprises means for communicating with a services platform, said communication means being capable of emitting HTTP GET requests toward the platform and of receiving requests in the XML-Phoenix format from the platform.

It is also an object of the present invention to provide an architecture for accessing audio files available from audio streaming servers, each audio file being located by an URL, characterized in that it comprises a terminal according to the preceding and a services platform capable of collecting from third-party servers heterogeneous resources-related data and converting them into the Phoenix format, and in that, when receiving a response in the XML-Phoenix format from the platform, the terminal is capable of connecting to the streaming server whose URL is contained in said response.

The present invention also relates to a communication method using the TCP/IP protocol between a user terminal and a services platform, said user terminal being capable of accessing an audio file available from an audio streaming server, said audio file being located by an URL,

characterized in that said method consists in:

authenticating the user terminal with the services platform;

updating the cache memory of the user terminal based on the information saved on said platform;

the terminal user emitting a request in the HTTP GET format toward the platform, said request comprising, among other things, the alias of an audio file;

the platform emitting a response in the XML-Phoenix format toward the user terminal, said response containing, among other things, the URL corresponding to said audio file, said terminal then connecting to the corresponding streaming server to access the audio file associated with said URL.

That is thanks to a network architecture comprising an additional services platform as well as a particular communication protocol between the platform and the user terminal that the present invention can provide a user terminal allowing reproduction of audio files from various sources, while having very few memory resources, and in particular very few read-only memory, which is known to be very costly.

The invention will be better understood and other purposes, details, features and advantages of the invention will become more clearly apparent from the description of a particular embodiment of the invention, which is given merely by way of illustrative and non-limitative example, with reference to the appended drawing, in which:

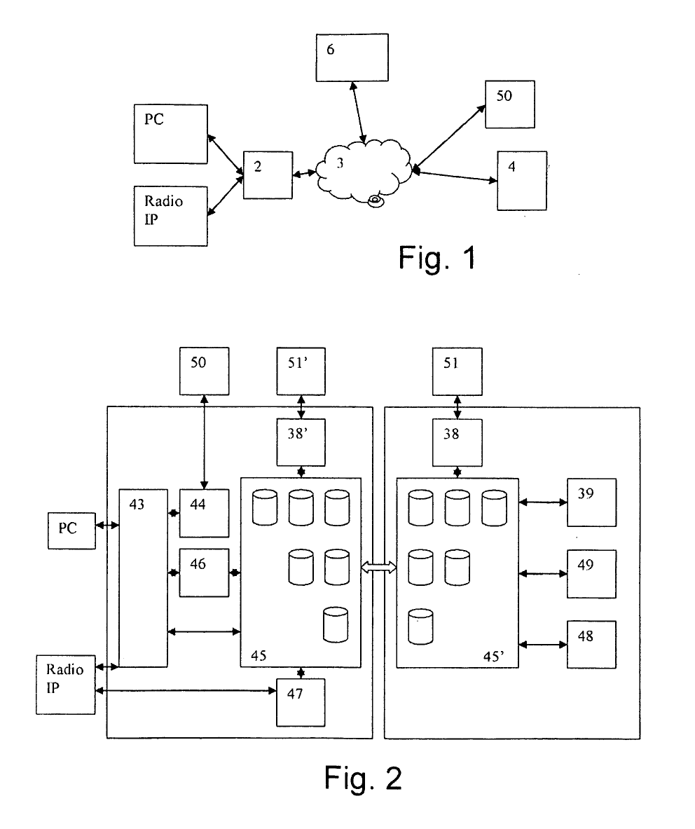

FIG. 1 is a schematic illustration of the architecture implemented according to the invention; and

FIG. 2 is a schematic illustration of the services platform of the architecture of FIG. 1.

The architecture of the audio stream broadcasting system according to the invention will now be described by means of the presently contemplated embodiment, with reference to FIG. 1. In this embodiment, the user terminal takes the form of radio alarm clock 1, located for example at the user's home. The radio alarm clock 1, hereinafter referred to as “Radio IP”, comprises sound-reproducing means such as loudspeakers for transforming an input electric signal into an acoustic wave; a man-machine interface MMI consisting of a screen, for example a liquid crystal display, for showing readable information to the user and a series of buttons and/or keys for enabling the user to interact and to input information: to browse a menu, to select a radio, to increase the sound volume, to modify the state of the Radio IP 1, etc.

From a hardware point of view, the Radio IP 1 comprises a processor and a memory for storing the value of some parameters and the instructions for programs adapted to be run by the processor. The Radio IP 1 comprises electronic boards and the input/output interfaces allowing, for some of them, display, use of buttons, loudspeakers management, etc., and, for the other ones, communication with a network 3.

From a software point of view, the Radio IP 1 comprises digital music decoders for transforming the data in standard formats such as WMA, MP3, WAV or the like, received from the network 3, into an input electric signal suited for the loudspeakers. These decoders are preferably in the form of software, but they could be in the form of electronic boards.

In the described embodiment, the Radio IP has three modes of use: “Time” mode, for everything that relates to the functions linked to what the user expects from an alarm clock (date and time display, alarm selection, etc.); “Audio” mode, for everything that relates to audio file playback (audio file selection, playback of this file, etc.); and “Configuration” mode, for everything that relates to the setting of the Radio IP 1 (sound level adjustment, screen adjustment, language selection, WIFI connection setting, etc.)

The network 3 is a network supporting the communication exchanges according to the HTTP protocol based on the TCP/IP protocol. For example, the network 3 is the Internet network or a corporate network (“Intranet”) or the like.

Communications between the Radio IP 1 and the network 3 can be performed directly though a wireline connection from the Radio IP 1 to a server of an access provider, but the connection to the network 3 is preferably made through a residential gateway 2, which is connected to the server through an ADSL link, for example. Communications between the Radio IP 1 and the residential gateway 2 are then performed by means of a wireless link of the WIFI or BLUETOOTH type, or the like (for example, powerline communication, WIMAX, but also 3G-type WCDMA system). Of course, the Radio IP 1 comprises those corresponding hardware and software means that make such communications possible. The use of a wireless local connection has the advantage of allowing the Radio IP 1 to be moved inside the area covered by the residential gateway 2.

The system according to the invention also comprises a services platform 4 connected to the network 3. The platform 4 will now be described in detail. The essential function of such platform is to collect the resources-related information from third-party servers. This information being in very heterogeneous proprietary formats, the matter is to transform it into a common format, in this case the PHOENIX format, in order to provide this information to the user via the Radio IP 1.

The platform 4 is divided into an in-line part 41 and an off-line part 42. The in-line part 41 (“front office”) will now be described in detail. It comprises a first interface 43 forming a virtual storefront supporting all the transactions with the user, whether the latter uses the Radio IP or a personal computer to connect to the services platform 4 over the Internet network. The virtual storefront 43 allows the requests emitted by the user to be responded, thanks to information retrieved in a database 45. For more complex tasks, the virtual storefront 43 communicates with a module called transaction engine 46.

The transaction engine 46 associates an identifier with the task required by the virtual storefront 43. It performs this complex task by applying the different adapted requests to the database 45. It stocks the result of this process until the virtual storefront 43 reemits a result request with the associated identifier. The transaction engine then responds by transmitting the result. The virtual storefront 43 also communicates with a payment module 44. The payment module 44, which is actually an engine similar to the transaction engine 46, communicates with a third-party server 50 for every exchange of confidential payment information. It is interesting to execute the payment-related transactions on a separate module because the communications with the third-party servers 50 are often slow, and it is advisable to have a dedicated module to distribute the load between the different modules of the in-line part 41. Finally, the platform 4 comprises an application module called supply module 47. The supply module 47 is an application that receives messages from the transaction engine 46 and that performs the data transfer between a content database and a supply database. The supply module 47 further contains a HTTP server capable of receiving requests from the user device for the data transfer. The supply module 47 directly interrogates the supply database to extract that information allowing this user request to be responded.

The database 45 of the in-line part 41 will now be described in detail. This database comprises several volumes assigned to different applications. The database 45 comprises a transaction database 45a that gathers the information about the complex operations that are being executed or that have been recently executed by the transaction engine 46; a user database 45b gathering the information about the user account, this information being basic information, notably user identification, and possibly identifying information allowing the connection to third-party servers, in the name of the user, in order to load specific contents to which the user is subscribed; an device profile database 45c gathering, for example, the MAC address of the Radio IP, the software version that is ran on this radio, etc.; a master database 45d or general catalogue containing the references of all the accessible resources; a database composed of the user catalogues 45e, each corresponding to an extraction from the general catalogue. The in-line part 41 is also equipped with modules 40, the function of which will be described hereinafter; and the above-described supply base 45f.

The off-line part 42 of the platform 4 will now be described in detail. It comprises a database 45′ which is a copy of the database 45 of the in-line part 41. This copy, which has been made at a previous instant of time T, is next enriched with contents and information, either by automated processes or directly by the administrator of the platform, etc. Then, at a frequency of about one hour, a synchronization step allows the database 45 to be updated, the data of the database 45′ replacing those of the database 45.

Several modules are executed on the off-line part and operate with the mirror database 45′. For example, just before the contents of the databases 45 and 45′ are synchronized, a test module 48 allows to perform a set of tests to ensure the content of the base 45′ is coherent. It is a quality procedure regarding the functioning of the installation. A statistic module 49 allows the making of any kind of calculation, such as noting the most wanted audio sources, monitoring the use made of a particular Radio IP, etc. Control module 39 comprises, for example, logs storing information about the errors of operation of the platform 4, and alert mechanisms enabling an alarm to be emitted in case of severe failure.

But the off-line part 42 of the platform 4 especially comprises a content management module 38 which allows to create and to update the general catalogue, and thus the particular catalogues, of the database 45′, by adding new references to contents, by enriching the meta-data associated with these contents (price of a disc), etc.

For this purpose, the content management module 38 periodically connects to third-party servers 51 comprising proprietary catalogues. These third-party servers 51 transmit the information about a particular source in an associated proprietary format, which is automatically converted into the PHOENIX format by the module 38, to be stored into the general catalogue of the database 45′. The content of this database is then synchronized with that of the database 45, to make these new contents available to the user.

The information supplied by the third-party servers 51′, which is intended to have a lifetime shorter than the synchronization period, for example one hour, are extracted and directly converted into the PHOENIX format in the in-line part 41, by the module 38′. For example, information about weather forecast and news-in-brief, available from a third-party server 51′ in a proprietary XML format (equivalent to the RSS format), are converted and then stored into the database 45 so as to by directly available.

Finally, the architecture according to the invention comprises audio content servers 6 capable of streaming data over the Internet network 3. Preferably, these servers are Internet servers making it possible to perform a dynamic “streaming” according to the nature of the receiver terminal. The resource's URL (the “Universal Resource Locator” is a pointer to a unique audio file) contained in the database 45 corresponds to the IP address of the server and to the access path to the corresponding audio file from the site of this machine. There is generally only one URL for each accessible audio file. It is possible to have several URLs to address a streaming server. In case of failure with the first URL, the user equipment decides to connect by means of the 2^{nd} URL, and so on.

Generally, when the user of the Radio IP 1 desires to listen to a radio, he/she selects the “AUDIO” mode. He/she then travels, by means of a selector of the control-pad type, through an arborescence displayed to him/her. At each hierarchical level, different menus are accessible. The lowermost level menu proposes a list of aliases of available audio resources.

When the user selects the alias “RADIO”, by pressing for example a “PLAY” button, a request in HTTP format, having the alias “RADIO” as a parameter, is emitted toward the platform 4 over the Internet network 3.

After extraction from the database 45 of the “RADIO_URL” corresponding to the alias “RADIO”, the services platform 4 responds by sending a response in XML format to the Radio IP 1. The XML file of the response comprises, among other things, as will be described in detail hereinafter, the “RADIO_URL” of the selected radio. When receiving this response, the Radio IP 1 connects to the “RADIO_URL” which as been indicated to it and which corresponds to an audio file located on the server 6. Thus, a request is emitted toward the server 6 for delivery of a content corresponding to that of the “RADIO_URL”. Finally, in response, the server 6 streams the content of the required file toward the Radio IP 1, over the Internet network 3.

Advantageously, in addition to the audio data stream, the server 6 can send additional data or “META_DATA” to the user terminal, so that the latter displays on the screen information about the track that is played. This information can be the title, the duration, the author or any other information directly related to the audio file.

During the use thereof, the Radio IP 1 offers a series of functionalities.

The functionality of choosing the source makes it possible, at a first hierarchical level, to choose for example among three possible audio data sources: live Radios, Radios on demand, or playback of the content of a USB key. It will be noticed that the Radio IP 1 detects insertion of a USB key and automatically displays the content of this key. Only the files of the USB key having the extension WMA, MP3 or WAV are proposed in the menu “My USB key”. The user chooses the source by browsing the menus and submenus. For example, the live radios are displayed by genre and the user can choose to display them by country. This functionality is accessible during the playback of a source. The user can then scroll the sources of the previously displayed list and choose a new source.

When the user places the Radio IP in “Audio” mode, the source previously heard is played again.

The source continues to be played until the user decides to stop or pause the playback, chooses another source, or switches to “Configuration” mode. As for a playback from a USB key, when a track is finished, the following one is played. At the end of the directory, the playback loops to the beginning. This loop is applied on the current directory and not on the whole files of the USB key.

The functionality of playing back a source, which besides can be activated when the Radio IP is in “Audio” mode, but also in “Time” mode, when an alarm triggers, intervene when the user, after having used the up and down arrows of the browsing pad to switch from one audio source to another, selects the source that is in the selection zone, for example by pressing the “Play” key. Of course, the Radio IP must be in communication with the services platform 4 via the WIFI gateway when the user selects one source and when the server for accessing this source next delivers the data stream.

When activated, the functionality of presetting allows the user, as soon as a source is played, to assign the source to a “Preset” key. A graphical or audio message confirms the success of the function to the user. The services platform is informed of the new preset. In this way, the source is assigned to the selected “Preset” button.

With the functionality of playing back a preset, the user can listen to this source directly by pressing the “Preset” button, when the Radio IP is in Time mode or Audio mode, without having to browse the menus and submenus of the interface. It will be noticed that the user can not assign a file of his/her USB key to a “Preset” key. It will also be noticed that, if the source is on the USB key, the latter has to be connected to the Radio IP, and if the source is an Internet source, the Radio IP has to be in communication with the services platform, via the WIFI gateway.

In the presently contemplated embodiment, the Radio IP also comprises a functionality of volume setting which is activated by the user whatever the mode in which the Radio IP operates. The user modifies the sound volume of the Radio IP from 0 to 100% by means of the corresponding button(s).

An equalizer functionality allows the user, when an audio source is played, to modify the bass and/or treble levels. The user can validate or cancel the modifications that have been done. Consequently, the treble and/or bass levels are immediately set in accordance with the settings chosen by the user. The treble and bass levels are saved in the user base when the Radio IP is powered off, and they can be specific to each audio source.

The user can choose to add the title currently played into a list of “favourites”. If the number of favourites of the list has reached a maximum number, for example 100, the older favourite is deleted. A message displayed during 5 seconds confirms to the user that the title has been added to the favourites. The title is thus added to the favourites list, and the following pieces of information are recorded in the Radio IP and transmitted to the services platform: meta-data; name of the radio; date and time of the recording as a favourite; music bought: yes/no (by default: no); buying code (by default: no code). For this functionality, the Radio IP has to be in communication with the services platform.

The user can also choose to delete a favourite. To this end, the user activates this functionality after having selected a favourite in the favourites list while in “Audio” mode. The corresponding title is deleted from the list. The services platform is informed of this favourites list updating, and the mirroring of the favourites list in the user database is synchronized. The Radio IP has to be in communication with the services platform via the WIFI gateway.

As a variant, the user can choose to delete all the favourites of the list.

A user that powers on his/her radio-set or that selects a new radio expects for a content to be immediately broadcasted. The user has the feeling of dysfunctioning beyond a one-second wait. Advantageously, the Radio IP implements one or more of the following strategies to immediately broadcast the content.

When the user browses the menu, the Radio IP connects to the X best sources, i.e. for example the X sources the most often listened to by this particular user. In background, the Radio IP plays back the corresponding sources. When the user actually selects a radio x, the playback of the corresponding source goes on with the broadcasting of the corresponding program, whereas the X−1 other data stream playback tasks are suspended. According to the bandwidth available at the considered instant of time and to the compression rate of the data played back from the various sources, the number X is recalculated every time and can thus vary. As a variant, the first seconds of the X sources are recorded on the services platform. When a particular source is selected, this few-seconds file is transferred from the platform toward the Radio IP for immediate playback. These few seconds give the Radio IP the time to access the server of the resource and give this server the time to start broadcasting the audio content. As soon as it receives the first data from the server, the Radio IP switches from the playback of the initial file to that of the stream. The switch can be the cause of a micro-interruption in the hearing of the content. In this embodiment variant, the bandwidth from the server must be wide, and the server must be capable of supporting a greater load.

The Radio IP can also make in possible to redirect the audio stream toward, for example, a portable phone. Each Radio IP is identified by a VoIP phone number. This portable phone makes a call toward this number and receives the steam played on the Radio IP at the time it connects, the Radio IP redirecting the data stream in real time in a coded format complying with the Voice-over-IP protocol. The Radio IP can decode key actuations on the portable phone (DTMF) so that the user of the phone can remotely browse the menu of the Radio IP to modify, for example, the played back audio source.

The Radio IP can also be equipped with a microphone. The audio signal picked-up by this microphone is transmitted over the Internet network (Voice over IP) to the services platform. The latter redirects the information stream toward the adapted application or service. For example, a voice server integrating a speech-recognition engine constructs, based on information extracted from the catalogue database, a response giving the address of an audio resource required by the user.

The general catalogue and the personal catalogue of a user contain so-called “editorial classification” information associated with each accessed source. For example, a popularity index of a source of the general catalogue can be determined by calculating the ratio of the total playing time of this source to the total playing time of all the sources of the same category or the same type, during one month, for example. Another example of a general indicator can be a technical score about the content server quality. Each time a user fails to read content from a server, the Radio IP sends a notification to the services platform. The platform then determines a technical score by counting the number of notifications regarding a same server during a given period of time. A too low technical score will allow the administrator of the platform to delete the corresponding sources from the database and to inform the administrator of the defaulting third-party server.

Personal indicators can also be determined, such as a score of satisfaction given by the user during the playback of a source, or information about the access frequency of a particular source with respect to the different resources of the user personal catalogue that are accessed during a predetermined period of time. This personal information about the behaviour of the user permits an automatic management of the personal catalogue, this automatic management being added to the direct management of the personal catalogue by the user via an Internet interface. Thus, if the sources of a same category are well scored, similar sources having received a good score from other users can be proposed to the user. If a source has a too low score during a period of time longer than three months, the corresponding source can be automatically deleted. It is possibly replaced by the source of the general catalogue having a good score according to the same criteria. If need be, when all the sources of a category have a bad score, the whole category can be automatically deleted from the personal catalogue of the user. It will then be no longer presented in the menu of the Radio IP. This functionality is for example interesting for upgrading the menu and in particular for upgrading the initial menu presented on the Radio IP just after a new user has identified. As the use of the Radio IP goes along, categories this user does not appreciate will be deleted to simplify the menu browsing. As a variant, the menu can be dynamically modified by presenting in first position the best-scored categories or resources.

The formats of the communication exchanges between the Radio IP 1 and the services platform 4 will now be described in detail. The DNS address of the platform 4 is RadioIP.phoenix.net. This address is an example and has to be replaced by the real DNS address of the platform used.

HTTP Header

All the requests emitted by the Radio IP 1 toward the platform 4 are of the HTTP GET type, with the systematic presence of a HTTP header which is detailed in the Table 1 below.

TABLEAU 1

| Name: content_example | Format | Description |
|---|---|---|
| http_USER_AGENT: | Specific: “liveradio/” followed | User-Agent specific of the Radio IP. |
| liveradio/1.0 | by the software version | |
| | number of the Radio IP | |
| HTTP_MAC_ADDRESS: | String(12)[0-9][A-F] | MAC address of the Radio IP. |
| 0123456789AB | | |
| HTTP_LOCATION: fr | String(2) | Language configured on the Radio |
| | | IP: FR = French/EN = English/SP = |
| | | Spanish/etc. |
| HTTP_TIME: +01:00 | String(5)[+][0-9][:][0-9] | Time zone configured on the Radio |
| | | IP: GMT offset in hours:minutes. |
| http_RADIO IP_PASSWORD: | String(32)[0-9][A-F] | Synchronization password |
| 00112233445566778899AAB | | calculated from the token assigned |
| CCDDEEFF | | to the Radio IP by the platform 4 at |
| | | the registration thereof. |
| HTTP_RADIO IP_SALT: 1234 | String(1 . . . 16)[0-9] | Salt used for the calculation of the |
| | | synchronization password. This salt |
| | | must always be incremented by at |
| | | least one unit between 2 calls of the |
| | | Radio IP to the platform 4. |
| HTTP_RADIO IP_MENUIDS: | String(0 . . . 8096)[0-9][,] | List of menu identifiers (MenuID), |
| 0,1,10,101 | | separated by commas, that the |
| | | Radio IP has accessed and |
| | | displayed to the user on its screen. |
| | | The requests made in background |
| | | for the cache updating are not |
| | | added to this header. |

Information Requests

The format of the GET parameters depends on the type of request that is made.

Automatic Updating of Date and Time:

http://Radio IP.phoenix.net/SvcRadio IP.php?WRequest=DateTime

The platform 4 sends in response an XML document according to the grammar Phoenix 1.0.0 (XML-P) containing the element <DateTime>, as detailed hereinafter.

Retrieving Content of One Menu:

http://Radio IP.phoenix.net/SvcRadio
IP.php?WRequest=Menu&WMenuID=_M_{—}

The platform 4 sends in response an XML-P document containing the element <Menu MenuID=“_M_”>, where _M_is replaced in the request and the response by the unique identifier of the desired menu. The value _M_{—}=0 is used to indicate the main menu, which is the starting node of all the menus.

Retrieving the Presets List of the Radio IP:

http://Radio IP.phoenix.net/SvcRadio IP.php?WRequest=Presets

The platform 4 sends in response an XML-P document containing the element <Presets>.

Retrieving the Favourites List of the Radio IP:

http://Radio IP.phoenix.net/SvcRadio IP.php?WRequest=Favourites

The platform 4 sends in response an XML-P document containing the element <Favourites>.

Retrieving the List from the Information Stream:

http://Radio IP.phoenix.net/SvcRadio IP.php?WRequest=Infos

The platform 4 sends in response an XML-P document containing the element <Infos>.

Refreshing the Cache of the Radio IP:

http://Radio IP.phoenix.net/SvcRadio IP.php?WRequest=Cache

The platform 4 sends in response an XML-P document containing the element <Cache>. This request allows the Radio IP to ask the platform 4 for the N last menus accessed, in order to refresh the cache memory of the Radio IP after a restart of the latter. In the preferred embodiment, N is equal to 100.

Modifying the Customized Data of the Radio IP

Modifying One Preset of the Radio IP

http://Radio IP.phoenix.net/SvcRadio

IP.php?WRequest=SetPreset&WButton=_B_&WMenuID=_M_{—}

_B_ and _M_ represent the identifier of the button (1-8) of the Radio IP and the unique identifier of the menu (defined by the services platform), respectively. The platform 4 sends in response an XML-P document containing the element <Presets>.

Adding One Favourite of the Radio IP

http://Radio IP.phoenix.net/SvcRadio

IP.php?WRequest=AddFavourite&WMenuID=_M_&WMetaData=_TEXT_{—}

_M_ and _TEXT_ represent the unique identifier of the menu in which the radio selected as a favourite has been presented to the user and the content of the meta-data associated with the favourite, respectively. The platform 4 sends in response an XML-P document containing the element <Favourites>.

Deleting One Favourite of the Radio IP

http://Radio IP.phoenix.net/SvcRadio

IP.php?WRequest=DelFavourite&WFavouriteID=_F_{—}

_F_ represents the unique identifier of the radio favourite to be deleted. The platform 4 sends in response an XML-P document containing the element <Favourites>.

Deleting all the Favourites of the Radio IP

http://Radio IP.phoenix.net/SvcRadio IP.php?WRequest=DelAllFavourites

The platform 4 sends in response an XML-P document containing the element <Favourites>.

Receiving the HTTP Response in XML Format

If the HTTP response is the code 200, any response made by the platform 4 to the Radio IP 1 is in the XML-P format described in the present document. Otherwise, only the HTTP error code is transmitted according to the usual HTTP protocol.

The XML Grammar Phoenix 1.0.0

The XML grammar Phoenix XML-P will now be described in detail.

Main Element <Phoenix>

Example in XML Format

<Phoenix Version=“1.0.0”>
...
</Phoenix>

Functions

It is the main element of Phoenix grammar. The presence thereof is systematic whatever the type of request made by the Radio IP.

In case of success, it must contain the authentication of an element of the type Cache, and possibly an element of the type Menu or Presets or Favourites or Infos or DateTime.

In case of error, it must contain a unique element Authentication.

Description of the Content

| Node | Field | E/A | Format | Nr | Description |
|---|---|---|---|---|---|
| Phoenix | Version | A | String(5) | 1 | Grammar version = 1.0.0 |
| | Authentication | E | Container | 0/1 | Authentication information. |
| | | | | | The presence thereof indicates either |
| | | | | | an error or a request for password |
| | | | | | resynchronization by the services |
| | | | | | platform. |
| | Cache | E | Container | 0/1 | Cache management. |
| | | | | | It indicates that the cache must be |
| | | | | | updated. |
| | Menu | E | Container | 0/1 | Audio Browsing. |
| | | | | | Returned in case of request for |
| | | | | | Audio Browsing. |
| | | | | | Mutually exclusive with the elements |
| | | | | | Presets, Favourites, Infos and |
| | | | | | DateTime. |
| | Presets | E | Container | 0/1 | Presets management. |
| | | | | | Returned in case of request for |
| | | | | | listing or modifying the radio presets. |
| | | | | | Mutually exclusive with the elements |
| | | | | | Menu, Favourites, Infos and |
| | | | | | DateTime. |
| | Favourites | E | Container | 0/1 | Favourites management. |
| | | | | | Returned in case of request for |
| | | | | | listing, adding or deleting of the |
| | | | | | favourites. |
| | | | | | Mutually exclusive with the elements |
| | | | | | Menu, Presets, Infos and DateTime. |
| | Infos | E | Container | 0/1 | Information stream management. |
| | | | | | Returned in case of request for |
| | | | | | information stream playback. |
| | | | | | Mutually exclusive with the elements |
| | | | | | Menu, Presets, Favourites and |
| | | | | | DateTime. |
| | DateTime | E | Empty | 0/1 | Date and time management. |
| | | | | | Returned in case of request for date |
| | | | | | and time updating. |
| | | | | | Mutually exclusive with the elements |
| | | | | | Menu, Presets, Favourites and Infos. |

Element <Authentication>

Examples in XML Format

```
<Phoenix Version=“1.0.0”>
  <Authentication>
    <Error Code=“1”>
      <TextLine Position=“1”>Resynchronisation</TextLine>
      <TextLine Position=“2”>demandée</TextLine>
    </Error>
    <Synchronization>
      <DefaultRadio IPPassword>
      00112233445566778899AABBCCDDEEFF
      </DefaultRadio IPPassword>
      <SetNewRadio IPToken>
      0123456789ABCDEFFEDCBA9876543210
      </SetNewRadio IPToken>
    </Synchronization>
  </Authentication>
  <Cache ValidityMenus=“90” ValidityPresets=“20”
  ValidityFavourites=“20” /> (...)
</Phoenix>
<Phoenix Version=“1.0.0”>
  <Authentication>
    <Error Code=“2”>
      <TextLine Position=“1”>Accès refusé</TextLine>
    </Error>
  </Authentication>
</Phoenix>
```

Functions

This element is returned following an authentication error or a request for resynchronization from the platform, whatever the request made by the Radio IP.

Description of the Content

| Node | Field | E/A | Format | Nr | Description |
|---|---|---|---|---|---|
| | Error | E | Container | 1 | Describes the authentication error. |
| Authentication | Synchronization | E | Container | 0/1 | Container of the resynchronization |
| | | | | | information. |
| | | | | | Present if Error.Code = 1. |
| Error | Code | A | Signed | 1 | Error code defined by the platform |
| | | | integer | | 4 following a problem of |
| | | | 32 bits | | authentication. |
| | | | | | The value 1 is reserved to the |
| | | | | | request for resynchronization. |
| | | | | | In this case, the element |
| | | | | | Synchronization must be present. |
| | TextLine | E | String (1-63) | 1-4 | Describes the authentication error. |
| | | | | | The maximum number of |
| | | | | | characters of a line depends on |
| | | | | | the variable size of the characters |
| | | | | | of the font. A line can display a |
| | | | | | minimum of 20 and a maximum of |
| | | | | | 63 characters (the line is then |
| | | | | | composed of 63 characters ‘i’). |
| TextLine | Position | A | Unsigned | 1 | Position of the static text line to be |
| | | | integer | | displayed on the screen of the |
| | | | 8 bits | | Radio IP. |
| | | | | | The authorized values are 1, 2, 3 |
| | | | | | et 4. |
| | DefaultRadio IP | E | String (32) | 1 | Factory-set default password of |
| | Password | | | | the Radio IP. It is equal to: |
| | | | | | HashMD5(MAC address + shared |
| | | | | | secret). |
| | | | | | The shared secret is not written in |
| | | | | | the present document for reasons |
| | | | | | of security. |
| | | | | | This password is necessary to |
| | | | | | ensure that it is well the platform 4 |
| | | | | | that requires resynchronization. |
| Synchronization | SetNewRadio | E | String (32) | 1 | New Token to be used by the |
| | IPToken | | | | Radio IP for calculating the |
| | | | | | synchronization password. |
| | | | | | This password is equal to: |
| | | | | | HashMD5(MAC address + shared |
| | | | | | secret + Radio IPToken + |
| | | | | | HTTP_RADIO IP_SALT) |

Element <Cache>

Examples in XML Format

```
    <Phoenix Version=“1.0.0”>
        <Cache ValidityMenus=“90” ValidityPresets=“20”
ValidityFavourites=“20”>
            <MustUpdateMenus>
                <MenuID>12</MenuID>
                <MenuID>34</MenuID>
                <MenuID>35</MenuID>
            </MustUpdateMenus>
            <MustUpdatePresets />
        <MustUpdateFavourites />
        </Cache>
    (...)
    </Phoenix>
    <Phoenix Version=“1.0.0”>
        <Cache ValidityMenus=“90” ValidityPresets=“20”
ValidityFavourites=“20”>
            <MustUpdatePresets />
        </Cache>
        (...)
    </Phoenix>
```

Functions

This element is returned whatever the request made by the Radio IP, from the moment the authentication is a success. It allows to keep the Radio IP cache optimally updated. The validity time-period count of each type of element (attributes ValidityMenus, ValidityPresets and ValidityFavourites) is reset as soon as an XML response containing an element <Cache> is received.

The list of MenuIDs returned for updating is the list of identifiers of the menus modified on the platform 4 between the last request of the Radio IP and the current request. The Radio IP has the task to check if these MenuIDs are defined in its cache and to make the request for retrieving the menus, in background, so as to update these menus.

Description of the Content

| Node | Field | E/A | Format | Nr | Description |
|---|---|---|---|---|---|
| | ValidityMenus | A | Signed integer | 1 | Time period (in seconds) during which the |
| | | | 32 bits | | menus cache stays valid. After this time period, |
| | | | | | it will be necessary to make sure the cache is |
| | | | | | updated, by making a request for menu |
| | | | | | retrieving. |
| | ValidityPresets | A | Signed integer | 1 | Time period (in seconds) during which the |
| | | | 32 bits | | presets cache stays valid. After this time period, |
| | | | | | it will be necessary to make sure the cache is |
| | | | | | updated, by making a request for retrieving the |
| | | | | | presets list. |
| Cache | Validity Favourites | A | Signed integer | 1 | Time period (in seconds) during which the |
| | | | 32 bits | | favourites cache stays valid. After this time |
| | | | | | period, it will be necessary to make sure the |
| | | | | | cache is updated, by making a request for |
| | | | | | retrieving the favourites list. |
| | MustUpdate | E | Container | 0/1 | Indicates that the cache of some menus must |
| | Menus | | | | be updated in the Radio IP. |
| | MustUpdate | E | Empty | 0/1 | Indicates that the cache of the presets list must |
| | Presets | | | | be updated in the Radio IP. |
| | MustUpdate | E | Empty | 0/1 | Indicates that the cache of the favourites list |
| | Favourites | | | | must be updated in the Radio IP. |
| MustUpdate | MenuID | E | Signed integer | 1-n | Unique identifier of the menu to be updated in |
| Menus | | | 32 bits | | the cache of the Radio IP. |

Element <Menu>

Examples in XML Format

```
  <Phoenix Version=“1.0.0”>
    <Cache VelidityMenus=“90” ValidityPresets=“20”
ValidityFavourites=“20” />
    <Menu MenuID=“10” Title=“Genre XY” IconID=“1”
    BackMenuID=“1”>
      <MenuItem MenuID=“12” Title=“Radio 1” IconID=“2” />
      <MenuItem MenuID=“34” Title=“Radio 2” IconID=“2” />
      <MenuItem MenuID=“35” Title=“Radio 3” IconID=“2” />
    </Menu>
  </Phoenix>
  <Phoenix Version=“1.0.0”>
  <Cache ValidityMenus=“90” ValidityPresets=“20”
  ValidityFavourites=“20”
/>
    <Menu MenuID=“35” Title=“Radio 3” IconID=“2”
    BackMenuID=“10”>
      <StreamDescription>
        <TextLines>
          <TextLine Position=“1”>Radio 3</TextLine>
        </TextLines>
        <StreamURLs>
          <StreamURL Host=“radio3.stream.net”
IPAddress=“1.2.3.4” Port=“80”>/radio3.stream.net/radio3</StreamURL>
          <StreamURL Host=“radio3.stream.com”
IPAddress=“1.2.5.6” Port=“80”>/radio3.stream.com/radio3</StreamURL>
        </StreamURLs>
        <StreamType>2</StreamType>
        <Access>1</Access>
        <Format>MP3</Format>
        <Codec>MP3</Codec>
        <BitRate>128</BitRate>
        <Channels>2</Channels>
        <SampleRate>44100</SampleRate>
        <Duration>180</Duration>
        <FileSize>1048576</FileSize>
        <VolumeAdjustment>0</VolumeAdjustment>
      </StreamDescription>
    </Menu>
  </Phoenix>
```

Functions

This element is returned for a request for information about content of one menu, whether it is at the time of first access to this menu or at the time of updating of the cache.

A menu is identified in a unique manner by an attribute MenuID defined on the services platform.

Description of the Content

| Node | Field | E/A | Format | Nr | Description |
|---|---|---|---|---|---|
| Menu | MenuID | A | Unsigned integer | 1 | Unique identifier of the menu |
| | | | 32 bits | | defined by the services platform. |
| | | | | | The value 0 indicates the first |
| | | | | | viewable menu. |
| | Title | A | String (1-63) | 1 | Title of the menu. |
| | | | | | The maximum number of |
| | | | | | characters depends on the |
| | | | | | variable size of the characters of |
| | | | | | the font. A line can display a |
| | | | | | minimum of 20 and a maximum of |
| | | | | | 63 characters (the line is then |
| | | | | | composed of 63 characters ‘i’). |
| | IconID | A | Unsigned integer | 1 | Type of icon associated with the |
| | | | 32 bits | | menu: |
| | | | | | 0 = no icon |
| | | | | | 1 = icon File |
| | | | | | 2 = icon Music note |
| | BackMenuID | A | Unsigned integer | 1 | Unique identifier of the return |
| | | | 32 bits | | menu defined by the services |
| | | | | | platform. |
| | MenuItem | E | Empty | 0-n | Element(s) describing the |
| | | | | | commands proposed by the |
| | | | | | menu. |
| | | | | | Mutually exclusive with the |
| | | | | | element StreamDescription. |
| | Stream | E | Container | 0/1 | Element(s) describing a radio |
| | Description | | | | station or a pre-recorded |
| | | | | | program. |
| | | | | | Mutually exclusive with the |
| | | | | | element MenuItem. |
| MenuItem | MenuID | A | Unsigned integer | 1 | Unique identifier of the menu |
| | | | 32 bits | | defined by the services platform. |
| | Title | A | String (1-255) | 1 | Title of the menu. |
| | | | | | The maximum number of |
| | | | | | characters that can be displayed |
| | | | | | on a line depends on the variable |
| | | | | | size of the characters of the font. |
| | | | | | A line can display a minimum of |
| | | | | | 20 and a maximum of 63 |
| | | | | | characters (the line is then |
| | | | | | composed of 63 characters ‘i’), |
| | | | | | with the margins and icons |
| | | | | | excepted. |
| | | | | | If all the characters can not be |
| | | | | | displayed, the line will be scrolled |
| | | | | | when selected. |
| | IconID | A | Unsigned integer | 1 | Type of icon associated with the |
| | | | 32 bits | | menu: |
| | | | | | 0 = no icon |
| | | | | | 1 = icon File |
| | | | | | 2 = icon Music note |
| Stream | TextLines | E | Container | 1 | Text lines to be displayed on the |
| Description | | | | | screen of the Radio IP to qualify |
| | | | | | the audio stream |
| | StreamURLs | E | Container | 1 | Available URLs to communicate |
| | | | | | with the audio streaming server |
| | StreamType | E | Unsigned integer | 1 | Stream type: |
| | | | 32 bits | | 1 = streaming |
| | | | | | 2 = file download |
| | | | | | 3 = progressive download |
| | Access | E | Unsigned integer | 1 | Stream access method: |
| | | | 32 bits | | 1 = http |
| | | | | | 2 = shoutcast |
| | | | | | 3 = mms |
| | | | | | 4 = mmsh |
| | Format | E | String (1-15) | 1 | Stream encapsulation format |
| | | | | | Ex: “MP3” or “ASF” |
| | Codec | E | String (1-15) | 1 | Stream audio Codec |
| | | | | | Ex: “MP3” or “WMA” |
| | BitRate | E | Unsigned integer | 0/1 | BitRate of the stream, kbps |
| | | | 32 bits | | |
| | Channels | E | Unsigned integer | 0/1 | Audio-channel number of the |
| | | | 8 bits | | stream: |
| | | | | | 1 = mono |
| | | | | | 2 = stereo |
| | SampleRate | E | Unsigned integer | 0/1 | Sampling rate of the stream, Hz |
| | | | 32 bits | | |
| | Duration | E | Unsigned integer | 0/1 | Duration (in seconds) in case of a |
| | | | 32 bits | | pre-recorded program: if |
| | | | | | StreamType = 2 or 3. |
| | FileSize | E | Unsigned integer | 0/1 | Size (in bytes) used in case of file |
| | | | 32 bits | | download: if StreamType = 2. |
| | Volume | E | Signed | 0/1 | Volume adjustment to be made |
| | Adjustment | | integer | | on the Radio IP. |
| | | | 8 bits | | Allows to obtain an equivalent |
| | | | | | audio level for all the streaming |
| | | | | | radios. |
| | | | | | Set to 0 for no adjustment. |
| TextLines | TextLine | E | String (1-63) | 1-4 | Static text lines to be displayed |
| | | | | | on the screen of the Radio IP to |
| | | | | | qualify the audio file. |
| | | | | | The maximum number of |
| | | | | | characters of a line depends on |
| | | | | | the variable size of the characters |
| | | | | | of the font. A line can display a |
| | | | | | minimum of 20 and a maximum of |
| | | | | | 63 characters (the line is then |
| | | | | | composed of 63 characters ‘i’). |
| TextLine | Position | A | Unsigned integer | 1 | Position of the static text line to |
| | | | 8 bits | | be displayed on the screen of the |
| | | | | | Radio IP. |
| | | | | | The authorized values are 1, 2, 3 |
| | | | | | et 4. |
| StreamURLs | StreamURL | E | String (1-1023) | 1-n | Available URL to communicate |
| | | | | | with the audio streaming server. |
| | | | | | It must begin by ‘/’. |
| StreamURL | Host | A | String (1-1023) | 1 | DNS name, if it exists, otherwise |
| | | | | | IP address of the stream. |
| StreamURL | IPAddress | A | String (7-15) | 1 | IP address of the stream, of the |
| | | | | | type aaa.bbb.ccc.ddd |
| StreamURL | Port | A | Unsigned integer | 1 | TCP port of the stream. |
| | | | 16 bits | | |

Element <Presets>

Examples in XML Format

```
  <Phoenix Version=“1.0.0”>
    <Cache ValidityMenus=“90” ValidityPresets=“20”
ValidityFavourites=“20” />
    <Presets>
      <Preset Button=“1” MenuID=“12” Title=“Radio 1” IconID=“2”
/>
      <Preset Button=“2” MenuID=“44” Title=“Radio A” IconID=“2”
/>
      <Preset Button=“3” MenuID=“45” Title=“Radio FF”
IconID=“2” />
      <Preset Button=“4” MenuID=“35” Title=“Radio 3” IconID=“2”
/>
      <Preset Button=“5” MenuID=“34” Title=“Radio 2” IconID=“2”
/>
      <Preset Button=“6” MenuID=“46” Title=“Radio Z” IconID=“2”
/>
      <Preset Button=“7” MenuID=“47” Title=“Radio E” IconID=“2”
/>
      <Preset Button=“8” MenuID=“99” Title=“Radio R” IconID=“2”
/>
    </Presets>
  </Phoenix>
```

Functions

This element is returned for a request for information about content of the presets list or for modifying of a preset.

A MenuID corresponding to the description of an audio stream is associated with each preset of the Radio IP.

Description of the Content

| Node | Field | E/A | Format | Nr | Description |
|---|---|---|---|---|---|
| Presets | Preset | E | Empty | 8 | Audio streaming preset. |
| Preset | Button | A | Unsigned | 1 | Identifier of the Preset button |
| | | | integer | | of the Radio IP. |
| | | | 8 bits | | The authorized values: 1, 2, |
| | | | | | 3, 4, 5, 6, 7 and 8 |
| | MenuID | A | Unsigned | 1 | Unique identifier of the menu |
| | | | integer | | defined by the services |
| | | | 32 bits | | platform. |
| | Title | A | String | 1 | Title of the preset menu. |
| | | | (1-255) | | The maximum number of |
| | | | | | characters that can be |
| | | | | | displayed on a line depends |
| | | | | | on the variable size of the |
| | | | | | characters of the font. A line |
| | | | | | can display a minimum of 20 |
| | | | | | and a maximum of 63 |
| | | | | | characters (the line is then |
| | | | | | composed of 63 characters |
| | | | | | ‘i’). |
| | | | | | If all the characters can not |
| | | | | | be displayed, the line will be |
| | | | | | scrolled when selected. |
| | IconID | A | Unsigned | 1 | Type of icon associated with |
| | | | integer | | the menu: |
| | | | 32 bits | | 0 = no icon |
| | | | | | 1 = icon File |
| | | | | | 2 = icon Music note |

Element <Favourites>

Examples in XML Format

```
  <Phoenix Version=“1.0.0”>
    <Cache ValidityMenus=“90” ValidityPresets=“20”
ValidityFavourites=“20” />
    <Favourites>
      <Favourite FavouriteID=“1” Title=“Auteur 1 − Chanson X”>
        <TextLine Position=“1”>“Auteur 1 − Chanson
X”</TextLine>
        <TextLine Position=“2”>écouté le 02 février
2006</TextLine>
        <TextLine Position=“3”>à 10h30</TextLine>
        <TextLine Position=“4”>sur Radio WXC</TextLine>
      </Favourite>
      <Favourite FavouriteID=“123” Title=“Auteur 2 − Chanson Y”>
        <TextLine Position=“1”>“Auteur 2 − Chanson
Y”</TextLine>
        <TextLine Position=“2”>écouté le 03 février
2006</TextLine>
        <TextLine Position=“3”>à 20h30</TextLine>
        <TextLine Position=“4”>sur Radio AZE</TextLine>
      </Favourite>
      <Favourite FavouriteID=“321” Title=“Auteur 3 − Chanson Z”>
        <TextLine Position=“1”>“Auteur 3 − Chanson
Z”</TextLine>
        <TextLine Position=“2”>écouté le 04 février
2006</TextLine>
        <TextLine Position=“3”>à 08h42</TextLine>
        <TextLine Position=“4”>sur France Inter</TextLine>
      </Favourite>
    </Favourites>
  </Phoenix>
```

Functions

This element is returned for a request for:
information about content of the favourites list;
adding one favourite;
deleting one favourite;
deleting all the favourites.

A unique identifier FavouriteID is associated with each favourite of the Radio IP.

Description of the Content

| Node | Field | E/A | Format | Nr | Description |
|---|---|---|---|---|---|
| Favourites | Favourite | E | Container | 1-n | Favourite of the Radio IP. |
| Favourite | FavouriteID | A | Unsigned | 1 | Unique identifier of the |
| | | | integer | | favourite defined by the |
| | | | 32 bits | | services platform. |
| | Title | A | String (1-255) | 1 | Title of the favourite. |
| | | | | | The maximum number of |
| | | | | | characters that can be |
| | | | | | displayed on a line depends |
| | | | | | on the variable size of the |
| | | | | | characters of the font. A line |
| | | | | | can display a minimum of 20 |
| | | | | | and a maximum of 63 |
| | | | | | characters (the line is then |
| | | | | | composed of 63 characters |
| | | | | | ‘i’). |
| | | | | | If all the characters can not |
| | | | | | be displayed, the line will be |
| | | | | | scrolled when selected. |
| | TextLine | E | String (1-255) | 4 | Text lines to be displayed on |
| | | | | | the screen of the Radio IP to |
| | | | | | qualify the favourite. |
| | | | | | The first line is scrolled if all |
| | | | | | the characters can not be |
| | | | | | displayed. The 3 other lines |
| | | | | | are static. |
| | | | | | The maximum number of |
| | | | | | characters that can be |
| | | | | | displayed on a line depends |
| | | | | | on the variable size of the |
| | | | | | characters of the font. A line can |
| | | | | | display a minimum of 20 |
| | | | | | and a maximum of 63 |
| | | | | | characters (the line is then |
| | | | | | composed of 63 characters |
| | | | | | ‘i’). |
| TextLine | Position | A | Unsigned | 1 | Position of the static text line |
| | | | integer | | to be displayed on the |
| | | | 8 bits | | screen of the Radio IP. |
| | | | | | The authorized values are 1, |
| | | | | | 2, 3 et 4. |

Element <Infos>

Examples in XML Format

```
  <Phoenix Version=“1.0.0”>
    <Cache ValidityMenus=“90” ValidityPresets=“20”
ValidityFavourites=“20” />
    <Infos GMTTimeOfNextRequest=“”>
      <Info StaticText=“News: ” IconData=“11azer”>
        <InfoItem ScrollingText=“Info1 − blabla1”
IconData=“99abcd” />
        <InfoItem ScrollingText=“Info2 − blabla2”
IconData=“88efgh” />
      </Info>
      <Info StaticText=“Demain: ” IconData=“13jklm”>
        <InfoItem ScrollingText=“Paris 10°” IconData=“qsdf33”
/>
        <InfoItem ScrollingText=“Nantes 11°”
IconData=“zerd44” />
      </Info>
      <Info StaticText=“Trafic: ” IconData=“12dfgh”>
        <InfoItem ScrollingText=“fluide” />
      </Info>
      <Info StaticText=“Wanadoo: ” IconData=“11azer”>
        <InfoItem ScrollingText=“Bonne année et Meilleurs
voeux !” />
        <InfoItem ScrollingText=“Nouvelle radio disponible :
RADIO AZE” IconData=“34dfvb” />
      </Info>
    </Infos>
  </Phoenix>
```

Functions

This element is returned for a request for content of the information stream.

The field Infos.GMTTimeOfNextRequest indicates the time (with an accuracy of one second) of the next request the Radio IP has to make. This enables the platform 4 to optimize the load induced by the HTTP requests of all the Radio IP to retrieve the next information stream.

Description of the Content

| Node | Field | E/A | Format | Nr | Description |
|---|---|---|---|---|---|
| Infos | GMTTimeOf | A | Time | 1 | Time of the next request the |
| | NextRequest | | hh:mm:ss | | Radio IP will have to make for |
| | | | | | retrieving the next information |
| | | | | | stream. |
| | Info | E | Container | 1-n | Information stream (news, |
| | | | | | weather forecast, traffic, |
| | | | | | Wanadoo, etc.) |
| Info | StaticText | A | String (1-31) | 1 | Title of the information stream. |
| | | | | | This title is displayed on the left |
| | | | | | of the screen, in the bottom part |
| | | | | | dedicated to the information |
| | | | | | stream. It is static. |
| | | | | | The maximum number of |
| | | | | | characters of a line depends on |
| | | | | | the variable size of the |
| | | | | | characters of the font. A line |
| | | | | | can display a minimum of 20 |
| | | | | | and a maximum of 63 |
| | | | | | characters (the line is then |
| | | | | | composed of 63 characters ‘i’). |
| | IconData | A | base64 | 0/1 | 2-colours B&W Icon of 9 * 9 |
| | | | | | pixels in the 2-colours B&W |
| | | | | | BMP format, coded in base64. |
| | | | | | The icon is displayed to the left |
| | | | | | of the static field. |
| | InfoItem | E | Empty | 1-n | List of content of the information |
| | | | | | stream. |
| InfoItem | ScrollingText | A | String (1-255) | 1 | Content of the information |
| | | | | | stream. |
| | | | | | This content is automatically |
| | | | | | scrolled, the number of |
| | | | | | character can thus exceed the |
| | | | | | maximum width of the screen of |
| | | | | | the Radio IP. |
| | IconData | A | base64 | 0/1 | 2-colours B&W Icon of 9 * 9 |
| | | | | | pixels in the 2-colours B&W |
| | | | | | BMP format, coded in base64. |
| | | | | | The icon is displayed to the left |
| | | | | | of the content of the field |
| | | | | | InfoItem. ScrollingText and is |
| | | | | | scrolled with this field. |

Element <DateTime>

Examples in XML Format

```
  <Phoenix Version=“1.0.0”>
    <Cache ValidityMenus=“90” ValidityPresets=“20”
ValidityFavourites=“20” />
    <DateTime Date=“27/02/2006” GMTTime=“13:59:47” />
  </Phoenix>
```

Functions

This element is returned for a request for automatic updating of time and date.

Description of the Content

| Node | Field | E/A | Format | Nr | Description |
|---|---|---|---|---|---|
| DateTime | Date | A | Date | 1 | Date to be updated. |
| | | | dd/mm/yyyy | | |
| | GMTTime | A | Time | 1 | Time to be updated. |
| | | | hh:mm:ss | | |

Managing the Cache of the Radio IP

The cache or cache memory is a limited-size memory volume for storing in the Radio IP 1 elements about the history of use thereof. It has for purpose to reduce the latency time when browsing the menus of the Radio IP 1, to allow operation even if the platform is not available (for example by ensuring a minimum service toward the radios servers the address of which are cached), and to reduce the load of the services platform by limiting the number of connections.

Cache Dimensioning

The SDRAM memory size reserved to the cache of the Radio IP 1 is of 500 Ko, which must allow, with an estimated average of 5 Ko by cached element, to save 100 elements in memory. It will exist far more than 100 possible elements to cache; however, after a phase of discovery of the Radio IP, it can be assessed that the user will always listen to the same type of audio content and will daily browse less than 100 menus.

The cache is not saved in the FLASH memory of the Radio IP 1, which allows to optimize the necessary size of the FLASH memory and to increase the lifetime of this memory, which is known to have a number of writing operations limited to about 100000.

Element Cache

The cache of the Radio IP according to the invention comprises three types of elements:
Content of the menus retrieved from the platform 4 during browsing by the user: each stored menu is indexed in the cache by its unique identifier MenuID defined by the platform. The cache stores the content of the XML element <Menu MenuID=“_M_”>. It should be borne in mind that the lowermost directory of the arborescence is no longer a list of menus but a list of aliases of accessible audio files. This list is considered as a menu;
Content of the presets list of the Radio IP: the presets list of the Radio IP is stored in the cache as a whole (corresponding to the XML element <Presets>) and is entirely replaced as soon as needed;
Content of the favourites list of the Radio IP: the favourites list of the Radio IP is stored in the cache as a whole (corresponding to the XML element <Favourites>) and is entirely replaced as soon as needed;

On the other hand, the XML element <Infos GMTTimeOfNextRequest=“_TIME_”> that describes the information stream is not considered in the management of the Radio IP cache because the updating thereof is systematic and set on a periodical basis according to the attribute _TIME_{—}

Cache Updating Information

The XML element <Cache> is systematically returned by the services platform, whatever the request made by the Radio IP, from the moment the authentication is a success. It allows to keep the Radio IP cache optimally updated. As mentioned above, the XML element <Cache> comprises the attributes ValidityMenus, ValidityPresets or ValidityFavourites, which indicates the validity time-period of each type of element of the cache. The validity time-period is reset as soon as an XML response containing a type of element to be updated is received.

As mentioned above, the cache is not saved when the Radio IP is powered off. The services platform saves each menu access from the Radio IP. At each new power on, the Radio IP emits a request for refreshing the cache to know the list of elements to be restored in its cache. The platform responds by giving, for example, the list of MenuIDs necessary to refresh the cache. The Radio IP then emits the necessary number of requests toward the services platform to retrieve each element.

In the particular case of the first power on of the Radio IP coming from the factory, the cache of the Radio IP is empty. After registration of the Radio IP with the services platform, and after the first HTTP GET request for refreshing the cache, the XML element <Cache> is returned to indicate the updating of the favourites list, the presets list as well as the menu whose MenuID is equal to 0: it is the base or root menu of the audio browsing. It enables the Radio IP to immediately retrieve customized data, the initial values of which correspond to a default profile.

```
  <Phoenix Version=“1.0.0”>
    <Cache ValidityMenus=“90” ValidityPresets=“20”
ValidityFavourites=“20”>
      <MustUpdateMenus>
        <MenuID>0</MenuID>
      </MustUpdateMenus>
      <MustUpdatePresets/>
      <MustUpdateFavourites/>
    </Cache>
  </Phoenix>
```

Request for Retrieving One Element

During a normal operation, if the Radio IP tries to access an element that is not present in the cache, the Radio IP waits for the response of the services platform to display the result on the screen, and then caches this response.

If the Radio IP tries to access an element that is present in the cache, two cases are possible.

If the validity time-period of the corresponding type of element has expired, a request is emitted toward the platform for retrieving the corresponding element. The HTTP headers of this request contain the list of the menus accessed by the Radio IP directly from the cache as long as the validity time-period has not expired. If the response is obtained within less than one second (a waiting time considered as acceptable by the user), the result is displayed on the screen and the cache is updated if need be. The response possibly contains an element <Cache> which indicates that other elements have to be updated in background without the user has to worry. If the response is obtained within more that one second, the result is displayed on the screen from the cache. When the response arrives in background, it is normally handled for the cache updating, but the display on the screen is not modified so as not to disturb the user. If a new request is emitted before the response arrives in background, the latter will follow the principle of the expired time-period.

On the other hand, if the validity time-period of the type of element has not expired, the result is displayed on the screen from the cache. No request is emitted toward the platform. The cache manager saves the information according to which this or that menu has been accessed, in order to inform the platform of it during the next request with an expired time-period.

The validity time-period is a parameter whose value is decided on the platform and assigned on the type-of-element basis: menus, presets and favourites. If the Radio IP uses a default profile, this validity time-period can be increased from one minute to tens of minutes, or event one hour, because only the administrator of the platform can modify content of the menus. The Radio IP is necessarily at the origin of the presets and favourites modifications: it can thus take these latter into account without making additional request. If the Radio IP uses a user profile liable to be modified by the user on the platform (by accessing the platform via a personal computer connected to the user site of the platform), even with keeping a short time-period, the principle stays interesting as regards the platform load. Moreover, when the user is connected via a personal computer to the user site of the platform, in order to modify his/her Radio IP profile, the platform can assign a validity time-period equal to zero to the next requests, until the user has closed his/her session on the user site. It allows to ensure that any modification made by the user on his/her Radio IP profile is immediately taken into account in his/her Radio IP.

Modifications Made on the Platform

It might be that the administrator of the platform would modify the menus. In this case, a list of the identifiers MenuID of the menus modified on the services platform between the last request of the Radio IP and the current request is returned by the platform in the purpose of updating. The Radio IP will ignore the updating information for the menus it does not accessed and will emit requests for retrieving menu-content for only the menus that were in its cache. To correctly fill up this list of identifiers MenuID of the modified menus, the services platform has to save the date and time of the last modification of each menu and the date and time of the last request made by the Radio IP. Thus, the platform returns only one time the list of modified elements to the Radio IP.

Management of the Menu Access Statistics

If some elements of the cache have to be updated following the reception of an element <Cache> in an XML response, the cache manager of the Radio IP emits requests in background, without informing the user of it. In this particular case, the HTTP_RADIO IP_MENUIDS header is not emitted.

In all the other cases, the HTTP_RADIO IP_MENUIDS header is emitted with the list of menus accessed from the cache since the last HTTP request emitted by the Radio IP. If the emitted request is for menu retrieval, the MenuID of this menu is included as the last element of the list of the HTTP_RADIO IP_MENUIDS header.

The Radio IP is thus used as follows: the user that desires to listen to a radio places the Radio IP in Audio mode. The user directly launches a preset or browses the preferred menus to select a radio. The duration of this selecting step can be assessed to a few dozen of seconds. The user tries some radios and then decides to listen to one during a few minutes or more.

Even with a short validity time-period, for example of about 90 s, the load of the services platform is reduced because only the first access (possibly unnecessary) is made, followed by some useful accesses to refresh the cache of the Radio IP.

Assuming that the user periodically browses 10 genres and tests at most 20 radios during the selection process, the cache system allows the Radio IP to make only one request to the services platform instead of the 30 systematic ones.

As a result of this particular management of the cache memory, the load of the services platform is advantageously highly reduced.

Besides, whatever the request made by the Radio IP with the services platform, the XML response can contain an element <Cache>. This allows a fast updating of the elements present in the cache of the Radio IP, even if the user did not yet access these elements. Further, this mechanism makes it possible to do without systematic periodic connections, but to take advantage of the useful connections to manage the content of the cache.

In conclusion, the request for refreshing the Radio IP cache makes it possible, on the one hand, to optimize the necessary size of memory on the Radio IP as well as the lifetime of this memory if the latter is of the FLASH type, and, on the other hand, to loose not any user information if the Radio IP is reset to the default factory settings.

Example of Use

The following steps chronologically follow on.

Cache Refreshing at the Power on of the Radio IP

```
  http://Radio IP.phoenix.net/SvcRadio IP.php?WRequest=Cache
  <Phoenix Version=“1.0.0”>
    <Cache ValidityMenus=“90” ValidityPresets=“20”
ValidityFavourites=“20”>
      <MustUpdateMenus>
        <MenuID>0</MenuID>
        <MenuID>1</MenuID>
        <MenuID>10</MenuID>
        <MenuID>101</MenuID>
      </MustUpdateMenus>
      <MustUpdatePresets />
      <MustUpdateFavourites />
    </Cache>
  </Phoenix>
  http://Radio IP.phoenix.net/
  SvcRadio IP.php?WRequest=Menu&WMenuID=0
  <Phoenix Version=“1.0.0”>
    <Cache ValidityMenus=“90” ValidityPresets=“20”
ValidityFavourites=“20” />
    <Menu MenuID=“0” Title=“Menu” IconID=“0” BackMenuID=“0”>
      <MenuItem MenuID=“1” Title=“Radios Live” IconID=“1” />
      <MenuItem MenuID=“2” Title=“Radios a la carte” IconID=“1”
/>
      <MenuItem MenuID=“3” Title=“Services Oranges” IconID=“1”
/>
    </Menu>
  </Phoenix>
  http://Radio IP.phoenix.net/
  SvcRadio IP.php?WRequest=Menu&WMenuID=1
  <Phoenix Version=“1.0.0”>
    <Cache ValidityMenus=“90” ValidityPresets=“20”
ValidityFavourites=“20” />
    <Menu MenuID=“1” Title=“Radios Live” IconID=“1”
    BackMenuID=“0”>
      <MenuItem MenuID=“10” Title=“Genre 1” IconID=“1” />
      <MenuItem MenuID=“20” Title=“Genre 2” IconID=“1” />
      <MenuItem MenuID=“30” Title=“Genre 3” IconID=“1” />
    </Menu>
  </Phoenix>
  http://Radio IP.phoenix.net/
  SvcRadio IP.php?WRequest=Menu&WMenuID=10
  <Phoenix Version=“1.0.0”>
    <Cache ValidityMenus=“90” ValidityPresets=“20”
ValidityFavourites=“20” />
    <Menu MenuID=“10” Title=“Menu” IconID=“1” BackMenuID=“1”>
      <MenuItem MenuID=“100” Title=“Radio 0” IconID=“2” />
      <MenuItem MenuID=“101” Title=“Radio 1” IconID=“2” />
      <MenuItem MenuID=“102” Title=“Radio 2” IconID=“2” />
    </Menu>
  </Phoenix>
  http://Radio IP.phoenix.net/
  SvcRadio IP.php?WRequest=Menu&WMenuID=101
  <Phoenix Version=“1.0.0”>
    <Cache ValidityMenus=“90” ValidityPresets=“20”
ValidityFavourites=“20” />
    <Menu MenuID=“101” Title=“Radio 1” IconID=“2”
    BackMenuID=“10”>
      <StreamDescription>
        <TextLines>
          <TextLine Position=“1”>Radio 1</TextLine>
        </TextLines>
        <StreamURLs>
  <StreamURL>http://radio1.stream.net/radio1</StreamURL>
  <StreamURL>http://radios.stream.com/radio1</StreamURL>
        </StreamURLs>
        <StreamType>1</StreamType>
        <Access>2</Access>
        <Format>MP3</Format>
        <Codec>MP3</Codec>
        <BitRate>128</BitRate>
        <Channels>2</Channels>
        <SampleRate>44100</SampleRate>
      </StreamDescription>
    </Menu>
  </Phoenix>
  http://Radio IP.phoenix.net/SvcRadio IP.php?WRequest=Presets
  <Phoenix Version=“1.0.0”>
    <Cache ValidityMenus=“90” ValidityPresets=“20”
ValidityFavourites=“20” />
    <Presets>
      <Preset Button=“1” MenuID=“101” Title=“Radio 1”
IconID=“2” />
      <Preset Button=“2” MenuID=“101” Title=“Radio 1”
IconID=“2” />
      <Preset Button=“3” MenuID=“101” Title=“Radio 1”
IconID=“2” />
      <Preset Button=“4” MenuID=“101” Title=“Radio 1”
IconID=“2” />
      <Preset Button=“5” MenuID=“101” Title=“Radio 1”
IconID=“2” />
      <Preset Button=“6” MenuID=“101” Title=“Radio 1”
IconID=“2” />
      <Preset Button=“7” MenuID=“101” Title=“Radio 1”
IconID=“2” />
      <Preset Button=“8” MenuID=“101” Title=“Radio 1”
IconID=“2” />
    </Presets>
  </Phoenix>
  http://Radio IP.phoenix.net/SvcRadio IP.php?WRequest=Favourites
  <Phoenix Version=“1.0.0”>
    <Cache ValidityMenus=“90” ValidityPresets=“20”
ValidityFavourites=“20” />
    <Favourites>
      <Favourite FavouriteID=“1” Title=“Auteur 1 - Chanson X”>
        <TextLine Position=1>“Auteur 1 - Chanson
X”</TextLine>
        <TextLine Position=2>ecoute le 02 fevrier
2006</TextLine>
        <TextLine Position=3>a 10h30</TextLine>
        <TextLine Position=4>sur Radio 1</TextLine>
      </Favourite>
      <Favourite FavouriteID=“2” Title=“Auteur 2 - Chanson Y”>
        <TextLine Position=1>“Auteur 2 - Chanson
Y”</TextLine>
        <TextLine Position=2>ecoute le 03 fevrier
2006</TextLine>
        <TextLine Position=3>a 20h30</TextLine>
        <TextLine Position=4>sur Radio 1</TextLine>
      </Favourite>
    </Favourites>
  </Phoenix>
```

The user browses the menus 0, 1, 10, 101 and 102 with his/her Radio IP 1 before the validity time-period expires (here: less than 90 s after the power on).

```
  http://Radio IP.phoenix.net/
  SvcRadio IP.php?WRequest=Menu&WMenuID=102
  HTTP_RADIO IP_MENUIDS: 0,1,10,101,102
  <Phoenix Version=“1.0.0”>
    <Cache ValidityMenus=“90” ValidityPresets=“20”
ValidityFavourites=“20” />
    <Menu MenuID=“102” Title=“Radio 2” IconID=“2”
    BackMenuID=“10”>
      <StreamDescription>
        <TextLines>
          <TextLine Position=“1”>Radio 2</TextLine>
        </TextLines>
        <StreamURLs>
  <StreamURL>http://radio2.stream.net/radio2</StreamURL>
  <StreamURL>http://radios.stream.com/radio2</StreamURL>
        </StreamURLs>
        <StreamType>1</StreamType>
        <Access>2</Access>
        <Format>MP3</Format>
        <Codec>MP3</Codec>
        <BitRate>128</BitRate>
        <Channels>2</Channels>
        <SampleRate>44100</SampleRate>
      </StreamDescription>
    </Menu>
  </Phoenix>
```

The user browses the menus 10, 102, 10, 101, 10 and 100 with his/her Radio IP 1 after the validity time-period has expired (here: more than 90 s after the last request).

```
  http://Radio IP.phoenix.net/
  SvcRadio IP.php?WRequest=Menu&WMenuID=10
  HTTP_RADIO IP_MENUIDS: 10
  <Phoenix Version=“1.0.0”>
    <Cache ValidityMenus=“90” ValidityPresets=“20”
ValidityFavourites=“20” />
    <Menu MenuID=“10” Title=“Menu” IconID=“1” BackMenuID=“1”>
      <MenuItem MenuID=“100” Title=“Radio 0” IconID=“2” />
      <MenuItem MenuID=“101” Title=“Radio 1” IconID=“2” />
      <MenuItem MenuID=“102” Title=“Radio 2” IconID=“2” />
    </Menu>
  </Phoenix>
  http://Radio IP.phoenix.net/
  SvcRadio IP.php?WRequest=Menu&WMenuID=100
  HTTP_RADIO IP_MENUIDS: 102,10,101,10,100
  <Phoenix Version=“1.0.0”>
    <Cache ValidityMenus=“90” ValidityPresets=“20”
ValidityFavourites=“20” />
    <Menu MenuID=“100” Title=“Radio 2” IconID=“2”
    BackMenuID=“10”>
      <StreamDescription>
        <TextLines>
          <TextLine Position=“1”>Radio 0</TextLine>
        </TextLines>
        <StreamURLs>
  <StreamURL>http://radio0.stream.net/radio0</StreamURL>
  <StreamURL>http://radios.stream.com/radio0</StreamURL>
        </StreamURLs>
        <StreamType>1</StreamType>
        <Access>2</Access>
        <Format>MP3</Format>
        <Codec>MP3</Codec>
        <BitRate>128</BitRate>
        <Channels>2</Channels>
        <SampleRate>44100</SampleRate>
      </StreamDescription>
    </Menu>
  </Phoenix>
```

The administrator modifies the URL of “Radio 1”. The user browses the menus 10, 102 with his/her Radio IP 1 after the validity time-period has expired (here: more than 90 s after the last request).

```
  http://Radio IP.phoenix.net/
  SvcRadio IP.php?WRequest=Menu&WMenuID=10
  HTTP_RADIO IP_MENUIDS: 10
  <Phoenix Version=“1.0.0”>
    <Cache ValidityMenus=“90” ValidityPresets=“20”
ValidityFavourites=“20”>
      <MustUpdateMenus>
        <MenuID>101</MenuID>
      </MustUpdateMenus>
    </Cache>
    <Menu MenuID=“10” Title=“Menu” IconID=“1” BackMenuID=“1”>
      <MenuItem MenuID=“100” Title=“Radio 0” IconID=“2” />
      <MenuItem MenuID=“101” Title=“Radio 1” IconID=“2” />
      <MenuItem MenuID=“102” Title=“Radio 2” IconID=“2” />
    </Menu>
  </Phoenix>
```

In the meantime, in background on the Radio IP:

```
  http://Radio IP.phoenix.net/
  SvcRadio IP.php?WRequest=Menu&WMenuID=101
  <Phoenix Version=“1.0.0”>
    <Cache ValidityMenus=“90” ValidityPresets=“20”
ValidityFavourites=“20” />
    <Menu MenuID=“101” Title=“Radio 1” IconID=“2”
    BackMenuID=“10”>
      <StreamDescription>
        <TextLines>
          <TextLine Position=“1”>Radio 1</TextLine>
        </TextLines>
        <StreamURLs>
  <StreamURL>http://radio1.stream.net/radio1_a</StreamURL>
  <StreamURL>http://radios.stream.com/radio1_a</StreamURL>
        </StreamURLs>
        <StreamType>1</StreamType>
        <Access>2</Access>
        <Format>MP3</Format>
        <Codec>MP3</Codec>
        <BitRate>128</BitRate>
        <Channels>2</Channels>
        <SampleRate>44100</SampleRate>
      </StreamDescription>
    </Menu>
  </Phoenix>
```

The user connects to the user sites of the platform to modify his/her Radio IP 1 profile. He/she accesses the menu 10 on his/her Radio IP after the validity time-period has expired (here: more than 90 s after the last request).

```
  http://Radio IP.phoenix.net/
  SvcRadio IP.php?WRequest=Menu&WMenuID=10
  HTTP_RADIO IP_MENUIDS: 102,10
  <Phoenix Version=“1.0.0”>
    <Cache ValidityMenus=“0” ValidityPresets=“0”
ValidityFavourites=“0” />
    <Menu MenuID=“10” Title=“Menu” IconID=“1” BackMenuID=“1”>
      <MenuItem MenuID=“100” Title=“Radio 0” IconID=“2” />
      <MenuItem MenuID=“101” Title=“Radio 1” IconID=“2” />
      <MenuItem MenuID=“102” Title=“Radio 2” IconID=“2” />
    </Menu>
  </Phoenix>
```

The user disconnects from the user site of the services platform. He/she accesses the menu 1 on his/her Radio IP after the validity time-period has expired (here: immediately because 0 s after the last request).

```
  http://Radio IP.phoenix.net/
  SvcRadio IP.php?WRequest=Menu&WMenuID=1
  HTTP_RADIO IP_MENUIDS: 1
  <Phoenix Version=“1.0.0”>
    <Cache ValidityMenus=“90” ValidityPresets=“20”
ValidityFavourites=“20” />
    <Menu MenuID=“1” Title=“Radios Live” IconID=“1”
    BackMenuID=“0”>
      <MenuItem MenuID=“10” Title=“Genre 1” IconID=“1” />
      <MenuItem MenuID=“20” Title=“Genre 2” IconID=“1” />
      <MenuItem MenuID=“30” Title=“Genre 3” IconID=“1” />
    </Menu>
  </Phoenix>
```

Password Synchronization

A minimum authentication mechanism has to be ensured between the Radio IP and the services platform to avoid, among other things, that any terminal or software other than the Radio IP connects to the platform 4 and retrieves information reserved to the Radios IP, or information about a particular Radio IP and thus the user thereof. But it is however necessary that any Radio IP coming from the factory can register with the services platform.

Of course, the process that is chosen must be simple and not very computation-intensive and allow a very large-scale integration. A resynchronization of the Radio IP password must also be possible at any moment, either on the initiative of the user (via his/her Radio IP profile) or on that of the administrator.

A non-encrypted transmission of the information being chosen, a mechanism forbidding the replay of the password has thus to be ensured so that an authentication password of the Radio IP can be used only one time. A protection against sniffers is thus provided.

Principle of Operation of the Password Synchronization

The cryptographic algorithm that is used consists only of the MD5 hash algorithm. The latter makes it possible to hash variable-size content and to output 16-bytes binary data that will be transformed into a result string of 32 hexadecimal characters (format “String(32)[0-9][A-F]”).

The result string forms the password. Any password will thus be formed of 32 hexadecimal characters. No symmetrical or asymmetrical encryption algorithm is used in the implemented solution.

The password is calculated from the elements described in the table below:

| Name | Format | Default value | Description |
|---|---|---|---|
| MAC address | String(12)[0-9][A-F] | MAC address of the | MAC address of the |
| | | WIFI dongle of the | Radio IP. |
| | | Radio IP. | The value is different |
| | | | for each Radio IP |
| | | | and is not modifiable. |
| Shared secret | String(32) | Not described in the | Shared secret |
| | | present document for | between the Radio IP |
| | | reasons of security. | and the services |
| | | | platform. |
| | | | The value is identical |
| | | | for each Radio IP |
| | | | and is not modifiable. |
| Radio IPToken | String(32) | Not described in the | Token assigned to |
| | | present document for | the Radio IP by the |
| | | reasons of security. | platform 4 at the time |
| | | | of registration of the |
| | | | Radio IP or during a |
| | | | resynchronization of |
| | | | the password. |
| | | | The initial value is |
| | | | identical on each |
| | | | Radio IP, then |
| | | | different after |
| | | | synchronization of |
| | | | the password. |
| | | | The initial value is |
| | | | kept by the Radio IP. |
| Radio IPSalt | String(1 . . . 10)[0-9] | 0 | Salt transmitted in |
| | | | clear for each |
| | | | request of the Radio |
| | | | IP. This salt must be |
| | | | always incremented |
| | | | by at least one unit |
| | | | between 2 calls of |
| | | | the Radio IP to the |
| | | | platform 4. When the |
| | | | platform 4 accepts |
| | | | the value |
| | | | 0xFFFFFFFF |
| | | | (4294967295 in |
| | | | decimal notation), a |
| | | | password |
| | | | resynchronization |
| | | | message is |
| | | | contained in the |
| | | | response to reset the |
| | | | value to 0 and to |
| | | | assign a new Radio |
| | | | IPToken. |

The password associated with the Radio IP is the result of applying the MD5 algorithm to the concatenation of the character strings MAC address, shared secret, Radio IPToken and Radio IPSalt.

Password = MD5 (MAC Address + shared secret + Radio IPToken +
Radio IPSalt )

Factory-Set Initial State

The initial password of the Radio IP coming from the factory is calculated from default values defined in the preceding paragraph. The MAC address is different for each Radio IP, the initial password resulting from the MD5 algorithm is completely different from one Radio IP to another.

Registration of the Radio IP

At the time of the first HTTP request transmitted by the Radio IP to the services platform, which can be either a time setting request or a cache refreshing, the factory-set initial password is sent in the HTTP header as the value of the parameter “HTTP_RADIO IP_PASSWORD”. The header parameter “HTTP_RADIO_IP_SALT” is set to 0. The header parameter “HTTP_MAC_ADDRESS” contains the MAC address of the Radio IP.

The platform 4 checks the validity of this initial password and transmits, in its XML response, an element <Authentication> with an error code set to 1 and a sub-element <Synchronization> for assigning to the Radio IP a new token “Radio IP Token”, which will be used in the next communication exchanges.

Below are given an example of response in case of success:

```
    <Phoenix Version=“1.0.0”>
        <Authentication>
            <Error Code=“1”>
                <TextLine Position=“1”>Enregistrement</TextLine>
                <TextLine Position=“2”>Radio IP</TextLine>
            </Error>
            <Synchronization>
              <DefaultRadio
IPPassword>00112233445566778899AABBCCDDEEFF
                </DefaultRadio IPPassword>
                <SetNewRadio
IPToken>0123456789ABCDEFFEDCBA9876543210
                </SetNewRadio IPToken>
            </Synchronization>
        </Authentication>
        (...)
    </Phoenix>
```

and an example of response in case of invalid password:

```
<Phoenix Version=“1.0.0”>
    <Authentication>
        <Error Code=“2”>
            <TextLine Position=“1”>Acces refuse</TextLine>
        </Error>
    </Authentication>
</Phoenix>
```

Requests of the Radio IP

For each HTTP request transmitted by the Radio IP toward the services platform, the password calculated with the token received at the time of registration of the Radio IP is transmitted as the value of the header parameter “HTTP_RADIO IP_PASSWORD”. The header parameter “HTTP_RADIO_IP_SALT” is set to the value used in the preceding request, incremented by one unit, or to the value 0 if a password resynchronization message has just been received by the Radio IP. The header parameter “HTTP_MAC_ADDRESS” always contains the MAC address of the Radio IP.

The platform has all the information necessary to check this password and thus to accept or not the request. Below is shown an example of response in case of valid password but with a value of the header parameter “HTTP_RADIO_IP_SALT” already used (the matter is to implement a protection against replay):

```
<Phoenix Version=“1.0.0”>
    <Authentication>
        <Error Code=“3”>
            <TextLine Position=“1”>Acces refuse</TextLine>
        </Error>
    </Authentication>
</Phoenix>
```

Password Resynchronization

If the Radio IP is reset with the factory settings, the password of the Radio IP becomes again the factory-set initial password. The token associated with the Radio IP is then no longer the same on the platform and on the Radio IP. In this case, the authentication result will be negative whatever the HTTP request emitted by the Radio IP.

To handle this problem, the platform must offer either the administrator or, possibly, the user via customization of his/her Radio IP profile, the possibility to reset the token associated with the Radio IP.

If a password resynchronization is initiated by the services platform then, whatever the nature or the next HTTP request emitted by the Radio IP, the password sent by the Radio IP will be accepted by the platform. Consequently, the XML response of the platform will contain an element <Authentication> with an error code set to 1 and a sub-element <Synchronization>. The process is similar to the registration of the Radio IP coming from the factory.

The field “DefaultRadio IPPassword” must correspond to the factory-set initial password of the Radio IP. To be capable of performing this checking, the Radio IP saves the initial value of the token, which is common to all the Radio IP. If this field does not correspond, the Radio IP does not accept the new token.

Following a password resynchronization, the next value of “Radio_IP_Salt” transmitted by the Radio IP will be equal to 0.

Below is given an example of response to a password resynchronization request:

```
  <Phoenix Version=“1.0.0”>
    <Authentication>
      <Error Code=“1”>
        <TextLine Position=“1”>Resynchronisation</TextLine>
        <TextLine Position=“2”>Radio IP</TextLine>
      </Error>
      <Synchronization>
        <DefaultRadio
IPPassword>00112233445566778899AABBCCDDEEFF
        </DefaultRadio IPPassword>
        <SetNewRadio
IPToken>0123456789ABCDEFFEDCBA9876543210
        </SetNewRadio IPToken>
      </Synchronization>
    </Authentication>
    (...)
  </Phoenix>
```

It will be noticed that a response with an authentication failure is impossible if a password resynchronization request has been initiated on the platform for the Radio IP.

Although the invention has been described with reference to a particular embodiment, it is not limited to this embodiment. It includes all technical equivalents to the described means as well as the combinations thereof that are within the scope of the invention.

1. A user terminal comprising:
storage means and calculation means;
a man-machine interface having display means and input means;
means for connection to a TCP/IP network, for accessing audio files available from audio streaming server, each audio file being located by an URL;
means for decoding the data stream transmitted by said server; and
means for reproducing sound from said decoded data stream,
characterized in that said storage means comprise a cache memory to store the terminal use history, said cache memory being a volatile memory and being of reduced size,
and in that said terminal further comprises means for communicating with a services platform, said communication means being capable of emitting HTTP GET requests toward the platform and of receiving requests in the XML-Phoenix format from the platform.

2. A terminal according to claim 1, characterized in that said cache memory comprises, among other things, the content of the last menus accessed by the user, a list of preset audio files, a list of preferred audio files.

3. An architecture for accessing audio files available from audio streaming servers, each audio file being located by an URL, characterized in that it comprises a terminal according to claim 1 and a services platform capable of collecting from third-party servers heterogeneous resources-related data and converting them into the Phoenix format, and in that, when receiving a response in the XML-Phoenix format from the platform, the terminal is capable of connecting to the streaming server whose URL is contained in said response.

4. An architecture according to claim 3, characterized in that said platform comprises:
an in-line part comprising a virtual storefront interface managing the communication exchanges with the user terminal; a transaction engine; a database comprising a general catalogue, a user catalogue, users and equipments profiles;
an off-line part comprising a copy of said database; and a module for collecting and converting heterogeneous resources-related data, capable of communicating with third-party servers and of recording the converted data into said database copy;
a means for synchronizing the content of the database copy of the off-line part with the database of the in-line part.

5. A communication method using the TCP/IP protocol between a user terminal and a services platform, said user terminal being capable of accessing an audio file available from an audio streaming server, said audio file being located by an URL,
characterized in that said method consists in:
authenticating the user terminal with the services platform;
updating the cache memory of the user terminal based on the information saved on said platform;
the terminal user emitting a request in the HTTP GET format toward the platform, said request comprising, among other things, the alias of an audio file;
the platform emitting a response in the XML-Phoenix format toward the user terminal, said response containing, among other things, the URL corresponding to said audio file, said terminal then connecting to the corresponding streaming server to access the audio file associated with said URL.

6. A method according to claim 5, characterized in that said step of updating the cache memory is performed a first time at the power-on of the user terminal, and in that said first step of updating comprises:
emitting a first request in the HTTP GET format to ask for a list of elements of the cache to be updated;
receiving a response in the XML-Phoenix format comprising the list of elements to be updated, said list being memorised in said cache memory.

7. A method according to claim 5, characterized in that each element of the cache comprises an attribute defining its validity time-period, and in that said step of cache updating is performed at expiry of this validity time-period for updating the corresponding element.

8. A method according to claim 5, characterized in that updating an element consists in emitting a HTTP GET request asking the services platform for the content of the element to be updated, followed by the platform emitting a response in the XML-Phoenix format giving the content of the element to be updated, wherein this request-response transaction can be performed in background.

9. A method according to claim 5, characterized in that said authentication step comprises a step of password synchronization consisting in the user terminal emitting a HTTP GET request with an initial password, then the platform emitting a response in the XML-Phoenix format with a token parameter value, the user terminal saving said token value in a read-only memory and constructing a new password for the subsequent requests based, among other things, on said token value.

10. A method according to claim 9, characterized in that the password associated with an Radio IP is the result of applying an algorithm MD5 to the concatenation of the character strings comprising at least the MAC address of the user terminal, the token value of the last synchronization step or, if not, the factory setting value, and the count value of the request-response transactions between the user and the platform from the last synchronization step.

11. An architecture for accessing audio files available from audio streaming servers, each audio file being located by an URL, characterized in that it comprises a terminal according to claim 2 and a services platform capable of collecting from third-party servers heterogeneous resources-related data and converting them into the Phoenix format, and in that, when receiving a response in the XML-Phoenix format from the platform, the terminal is capable of connecting to the streaming server whose URL is contained in said response.

12. A method according to claim 6, characterized in that each element of the cache comprises an attribute defining its validity time-period, and in that said step of cache updating is performed at expiry of this validity time-period for updating the corresponding element.

13. A method according to claim 6, characterized in that updating an element consists in emitting a HTTP GET request asking the services platform for the content of the element to be updated, followed by the platform emitting a response in the XML-Phoenix format giving the content of the element to be updated, wherein this request-response transaction can be performed in background.

14. A method according to claim 7, characterized in that updating an element consists in emitting a HTTP GET request asking the services platform for the content of the element to be updated, followed by the platform emitting a response in the XML-Phoenix format giving the content of the element to be updated, wherein this request-response transaction can be performed in background.
